(19) United States
(12) Patent Application Publication
(10) Pub. No.: US 2025/0083546 A1
(43) Pub. Date: Mar. 13, 2025

(54) CHARGING PILE

(71) Applicant: Shenzhen Guanke Technologies Co., Ltd, Shenzhen (CN)

(72) Inventors: Qing LAN, Shenzhen (CN); Ligen LIU, Shenzhen (CN); Qinwan GONG, Shenzhen (CN)

(73) Assignee: Shenzhen Guanke Technologies Co., Ltd, Shenzhen (CN)

(21) Appl. No.: 18/829,575

(22) Filed: Sep. 10, 2024

(30) Foreign Application Priority Data
Sep. 11, 2023 (CN) 202311170227.6

(51) Int. Cl. B60L 53/31

(52) U.S. Cl. CPC B60L 53/31

(57) ABSTRACT

A charging pile, including: a housing, an electric control component provided in the housing, and a charging gun cable. One end of the charging gun cable is electrically connected to the electric control component, and the other end of the charging gun cable is connected to the charging gun tip. The housing includes an installation portion disposed close to a wall plate, a limiting portion disposed opposite to the installation portion, and a supporting portion disposed between the installation portion and the limiting portion. The limiting portion is disposed higher than the supporting portion, to keep the charging gun cable on the supporting portion. A groove is provided at the middle position of the supporting portion, and the groove allows part of the charging gun cable on the supporting portion to be in a suspended state.

### CROSS-REFERENCE TO RELATED APPLICATIONS

This application claims priority to Chinese Patent Application No. 202311170227.6, filed on Sep. 11, 2023, the entire contents of which are incorporated herein by reference.

### TECHNICAL FIELD

The present application relates to the technical field of charging equipments, and in particular to a charging pile.

### BACKGROUND

Green travel has become a development trend, and the charging equipment is the most important supporting facility for new energy vehicles. Improvement and promotion of charging equipments will directly determine whether new energy vehicles can be fully developed.

Charging piles, referring to charging equipments that provides charging services for electric vehicles, can be fixed on the ground or wall, and can be installed in public buildings (such as public buildings, shopping malls, public parking lots, and the like), residential parking lots, or charging stations. Various models of electric vehicles can be charged by the charging pile according to different voltage levels. The charging pile is usually equipped with a charging pile body, a charging gun and a charging gun cable. It is important to protect and store the charging gun cable. At present, by disposing a hook close to the charging pile or directly disposing a hook on the charging pile body, the charging gun cable can be stored.

After driving the vehicle to a position of the charging pile, the driver will insert the charging gun of the charging pile into the charging port of the electric vehicle to charge the vehicle. After charging, the charging gun tip is plugged into a gun seat (that is, the charging pile is equipped with a gun seat), or the charging gun and the charging gun cable are hung on a hook, or the charging gun cable is even discarded on the ground, so that the charging gun cable may be soaked in sewage, polluted on the ground, or even crushed by a vehicle. Besides, there are many defects when a hook is provided at the charging pile additionally, for example, a lot of space may be occupied, the charging gun cable may slip easily due to an unstable structure of the hook, it is inconvenient for users to take the charging gun cable, and the like.

### SUMMARY

The main purpose of the present application is to provide a charging pile, aiming to solve the technical problem that it is inconvenient for users to take the charging gun cable of the existing charging pile.

To achieve the above purpose, the present application provides a charging pile including: a housing, an electric control component provided in the housing, and a charging gun cable. One end of the charging gun cable is electrically connected to the electric control component, and the other end of the charging gun cable is connected to a charging gun tip. The housing includes an installation portion disposed close to a wall plate, a limiting portion disposed opposite to the installation portion, and a supporting portion provided between the installation portion and the limiting portion. The limiting portion is disposed higher than the supporting portion to keep the charging gun cable on the supporting portion. A groove is provided at a middle position of the supporting portion, and the groove is configured to enable part of the charging gun cable on the supporting portion to be in a suspended state.

In an embodiment, the installation portion is configured to extend at least along a vertically upward direction, to make a top end of the installation portion higher than the supporting portion; and the limiting portion and the installation portion are configured to limit the charging gun cable on the supporting portion.

In an embodiment, a top end of the installation portion is disposed lower than the supporting portion; and the limiting portion and the wall plate are configured to limit the charging gun cable on the supporting portion.

In an embodiment, the groove is provided with a notch facing the installation portion.

In an embodiment, a side projection of the supporting portion is horizontal; a connection position between the limiting portion and the supporting portion is provided with a first arc chamfer, and a connection position between the supporting portion and the installation portion is provided with a second arc chamfer.

In an embodiment, a side of the supporting portion and a side of the limiting portion are in a same plane; and/or a vertical distance between the supporting portion and a top end of the limiting portion is greater than a cross-sectional radius of the charging gun cable.

In an embodiment, the housing further includes an interaction surface, and the interaction surface is provided at a side of the housing away from the installation portion.

In an embodiment, the interaction surface is provided with a convex portion extending obliquely downward along a top end of the limiting portion; an accommodation cavity for holding the charging gun tip is provided in the convex portion; and a angle between a top surface of the convex portion and a vertical direction is in a range of 0° to 60°.

The present application further provides a charging pile including a housing, an electric control component provided in the housing, a charging gun cable, and a line holder sleeved outside the charging gun cable. One end of the charging gun cable is electrically connected to the electric control component, and the other end of the charging gun cable is connected to a charging gun tip. The housing includes an installation portion disposed close to a wall plate, a limiting portion disposed opposite to the installation portion, and a supporting portion provided between the installation portion and the limiting portion; and the limiting portion is disposed higher than the supporting portion to keep the line holder on the supporting portion.

In an embodiment, the line holder includes a lifting portion and a gripping portion, and a circumferential size of the lifting portion is larger than a circumferential size of the gripping portion, to allow a gap between the lifting portion and the supporting portion for fingers to reach.

In an embodiment, a groove is provided in a middle of the supporting portion.

In an embodiment, the groove is provided with a notch facing the installation portion; each cross-sectional radius of both ends of the line holder is greater than a cross-sectional radius of a middle position of the line holder; and in response to that the line holder is provided at the supporting portion, both ends of the line holder are abutted against the wall plate, to allow a gap between a middle position of the line holder and the wall plate for fingers to reach.

In an embodiment, a top end of the installation portion is disposed lower than the supporting portion, and the limiting portion and the wall plate are configured to limit the line holder on the supporting portion; or the installation portion is configured to extend at least along a vertically upward direction to make a top end of the installation portion higher than the supporting portion, and the limiting portion and the installation portion are configured to limit the line holder on the supporting portion.

In an embodiment, the line holder is shaped in a dumbbell; a length of a middle position of the line holder is greater than a length of a line connecting two side surfaces of the supporting portion; and/or a matching gap is provided between the line holder and the charging gun cable; and/or the line holder is made of a flexible material with elastic recovery.

In the technical solutions of the present application, the electric control component is provided in the housing. One end of the charging gun cable is electrically connected to the electric control component, and the other end of the charging gun cable is connected to the charging gun tip. The charging gun tip can be plugged into the charging interface of the electric vehicle to charge the vehicle. The electric control component converts the mains supply into the safe current suitable for charging the electric vehicle, and charging will be finished through the charging gun cable and the charging gun tip. The housing includes an installation portion disposed close to a wall plate, a limiting portion disposed opposite to the installation portion, and a supporting portion disposed between the installation portion and the limiting portion. The supporting portion is used for holding and accommodating the charging gun cable, and is used for supporting the charging gun cable. The limiting portion is disposed higher than the supporting portion, to keep the charging gun cable on the supporting portion, and the supporting portion can prevent the charging gun cable from being damaged. A groove is provided at the middle position of the supporting portion, and the groove allows part of the charging gun cable on the supporting portion to be in a suspended state. That is, the groove is provided at the middle position of the supporting portion, so that the supporting portion is shaped in a structure with high edges on both sides and a middle depression. The charging gun cable is horizontally disposed at the supporting portion, and the recessed portion in the middle position of the supporting portion makes the part of the charging gun cable located on the supporting portion in a suspended state, which is convenient for the user to grasp the charging gun cable. Or, by arranging the electric control component in the shell housing, one end of the charging gun cable is electrically connected to the electric control component, and the other end is connected to the charging gun tip, the charging gun tip is used to be plugged into the charging port of the vehicle, and the line holder is slidably sleeved on the charging gun cable. The housing includes an installation portion disposed close to a wall plate, a limiting portion disposed opposite to the installation portion, and a supporting portion disposed between the installation portion and the limiting portion. The limiting portion is disposed higher than the supporting portion, to keep the charging gun cable on the supporting portion, and the line holder is arranged on the charging gun cable, so that it is more convenient for the user to take and place the charging gun cable.

### BRIEF DESCRIPTION OF THE DRAWINGS

One or more embodiments are exemplarily described with reference to accompanying drawings, which do not constitute limitations on the embodiments. Elements with same reference numerals in the accompanying drawings represent similar elements, and figures in the accompanying drawings do not constitute proportional limitations unless otherwise stated.

FIG. 1 is a schematic structural diagram of the charging pile according to a first embodiment and a second embodiment of the present application from a first perspective.

FIG. 2 is a schematic structural diagram of the housing installed at the wall plate according to the first embodiment of the present application.

FIG. 3 is a schematic structural diagram showing the placement of the housing and the charging gun cable according to the second embodiment of the present application.

FIG. 4 is a schematic structural diagram of the charging pile according to the first embodiment of the present application from a second perspective.

FIG. 5 is a schematic structural diagram showing the charging gun tip being plugged into the housing according to the first embodiment of the present application from the first perspective.

FIG. 6 is a schematic structural diagram showing the charging gun tip being plugged into the housing according to the first embodiment of the present application from the second perspective.

FIG. 7 is a schematic structural diagram of the charging pile according to a third embodiment and a fourth embodiment of the present application from the first perspective.

FIG. 8 is a schematic structural diagram of the charging pile according to a third embodiment and a fourth embodiment of the present application from the second perspective.

FIG. 9 is a schematic structural diagram of the housing installed at the wall plate according to the third embodiment of the present application.

FIG. 10 is a schematic structural diagram of the housing according to the third embodiment of the present application.

FIG. 11 is a first schematic structural diagram of the line holder according to the third embodiment of the present application.

FIG. 12 is a first schematic structural diagram of the line holder according to the fourth embodiment of the present application.

FIG. 13 is a second schematic structural diagram of the line holder according to the fourth embodiment of the present application.

### DETAILED DESCRIPTION OF THE EMBODIMENTS

To facilitate the understanding of the present application, a more detailed description of the present application is given below in conjunction with the accompanying drawings and embodiments.

In addition, the technical features in the different embodiments of the present application described below can be combined with each other as long as they do not conflict with each other.

### The First Embodiment

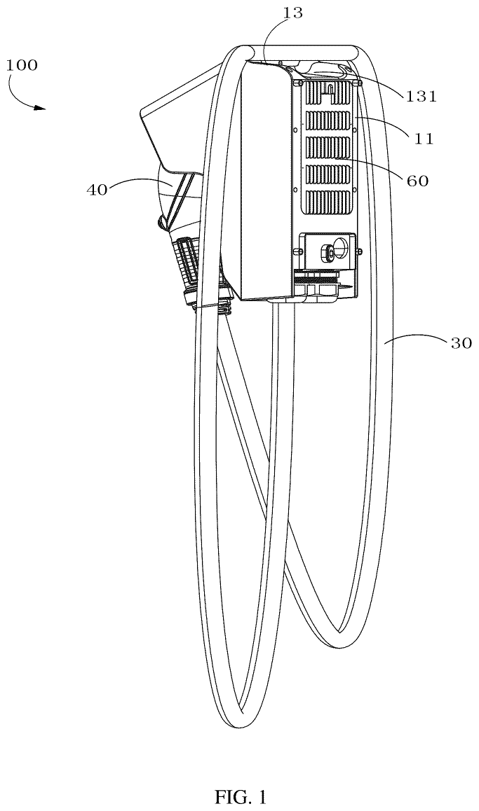

As shown in FIG. 1 to FIG. 5, embodiments of the present application provide a charging pile 100, which is installed at a wall plate extending in a vertical direction, such as a wall surface or a column surface, and is configured to charge an electric vehicle.

The charging pile 100 includes a housing 10, an electric control component 20, a charging gun cable 30, and a charging gun tip 40. The electric control component 20 is provided in the housing 10, and is configured to convert the mains supply into the safe current (including the alternating current and the direct current) suitable for charging electric vehicles. The electric control component 20 is a general term for a control board and various integrated components.

One end of the charging gun cable 30 is electrically connected to the electric control component 20, and the other end of the charging gun cable 30 is connected to the charging gun tip 40. The charging gun tip 40 can be plugged into the charging interface of the electric vehicle to charge the vehicle. That is, the charging gun tip 40 is plugged into the charging interface of the vehicle, and the electric control component 20 converts the mains supply into the safe current suitable for charging the electric vehicle, and charging will be finished through the charging gun cable 30 and the charging gun tip 40.

The housing 10 includes an installation portion 11 disposed close to a wall plate 200, a limiting portion 12 disposed opposite to the installation portion 11, and a supporting portion 13 disposed between the installation portion 11 and the limiting portion 12. The supporting portion 13 is used for holding and accommodating the charging gun cable 30, and is used for supporting the charging gun cable 30. The limiting portion 12 is disposed higher than the supporting portion 13, to keep the charging gun cable 30 on the supporting portion 13. That is, in the vertical direction, the height of the limiting portion 12 is greater than the height of the supporting portion 13, so that the limiting portion 12 protrudes from (is higher than) the supporting portion 13 in the vertical direction to form a protrusion portion, and the protrusion portion limits the charging gun cable 30 on the supporting portion 13. The charging gun cable 30 will be placed on the supporting portion 13 in time after use, to prevent the charging gun cable 30 from being crushed by a vehicle or stepped on by a user, thereby avoiding damage to the charging gun cable 30. In addition, a supporting portion 13 is provided at the charging pile 100 to support the charging gun cable 30 without an additional storage device, so that the charging pile 100 has a compact structure with a reduced volume to avoid occupying space, and as many charging piles 100 as possible can be provided in a limited space to meet user needs. A groove 131 is provided at the middle position of the supporting portion 13, and the groove 131 allows part of the charging gun cable 30 on the supporting portion 13 to be in a suspended state. That is, the groove 131 is provided at the middle position of the supporting portion 13, so that the supporting portion 13 is shaped in a structure with high edges on both sides and a middle depression. The charging gun cable 30 is horizontally disposed at the supporting portion 13, and two side edges are formed by the groove 131 to support the charging gun cable 30. There is a gap between the portion of the charging gun cable 30 at the groove 131 and the bottom of the groove 131, so that part of the charging gun cable 30 disposed on the supporting portion 13 is in a suspended state. The length of the groove 131 along the direction from the installation portion 11 to the limiting portion 12 is greater than the diameter of the charging gun cable 30, and a gap for user's fingers to reach is reserved along the radial direction of the charging gun cable 30, so that the user can reach and take the charging gun cable 30.

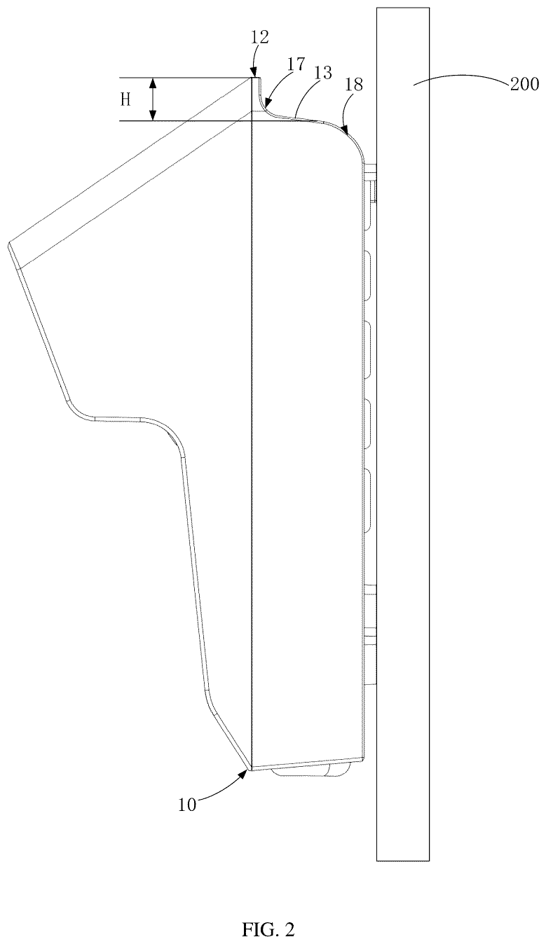

In order to take the charging gun cable 30 more conveniently, the installation portion 11 is disposed lower than the supporting portion 13, and the groove 131 is provided with a notch along the direction toward the installation portion 11, so as to adapt to the user's habit of extending fingers from one side of the installation portion 11 into the groove 131 to hold the charging gun cable 30. In an embodiment, as shown in FIG. 2, the top end of the installation portion 11 is disposed lower than the supporting portion 13, so that the user can conveniently reach out his finger into the groove 131 from one side of the installation portion to take the charging gun cable 30. The limiting portion 12 and the wall plate 200 limit the charging gun cable 30 on the supporting portion 13, that is, the installation portion 11 of the charging pile 100 is fixed to the wall plate 200, so that the limiting portion 12 and the wall plate 200 form a limiting space, thereby limiting the charging gun cable 30 on the supporting portion 13. The charging pile 100 can limit the charging gun cable 30 on the supporting portion 13 by virtue of the wall plate 200 without an additional storage device, so that the structure of the charging pile 100 is compact and the volume is reduced. In addition, when the groove 131 is provided with a notch along a direction facing the installation portion, the user can more conveniently reach out his finger into the groove 131 through the notch to take the charging gun cable 30.

In this embodiment, the installation portion 11 of the charging pile 100 is fixed on the wall plate 200, so that the limiting portion 12, the supporting portion 13 and the wall plate 200 form a limiting space, and the charging gun cable 30 is placed in the limiting space, and the limiting space can limit the charging gun cable 30 on the supporting portion 13. When charging, the charging gun cable 30 is removed from the supporting portion 13, and the groove 131 allows the charging gun cable 30 corresponding to the position of the groove 131 to be in a suspended state. The notch makes it convenient for the user to take the charging gun cable 30 from the notch and remove the charging gun cable 30, and then insert the charging gun tip 40 into the charging port of the vehicle to charge the vehicle. After charging, the charging gun cable 30 is placed on the supporting portion 13 for fixing, so as to prevent the charging gun cable 30 from being scattered on the ground and being crushed by the vehicle or stepped on by the user, resulting in damage to the charging gun cable 30.

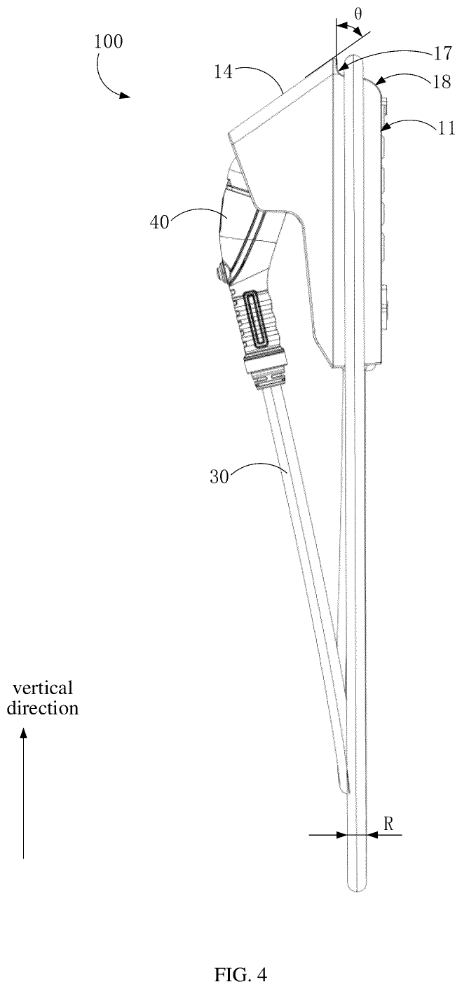

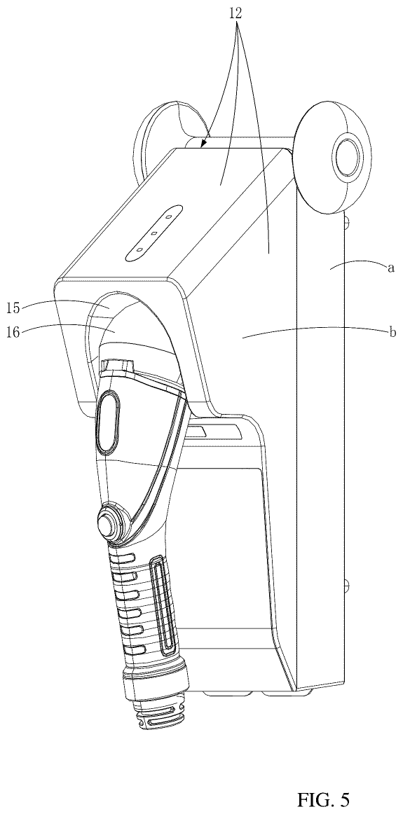

In order to make the housing more beautiful, the side projection of the supporting portion 13 is basically horizontal. A connection position between the limiting portion 12 and the supporting portion 13 is provided with a first arc chamfer 17, and a connection position between the supporting portion 13 and the installation portion 11 is provided with a second arc chamfer 18. The side a of the supporting portion and the side b of the limiting portion are basically in the same plane. In an embodiment, as shown in FIG. 2, FIG. 4 and FIG. 5, the side projection of the supporting portion 13 is basically horizontal, so that the charging gun cable 30 can be stably placed and stored on the supporting portion 13 to prevent the charging gun cable 30 from tipping over to one side. The basically horizontal state includes two states, one state means that the side projection of the supporting portion 13 is infinitely close to horizontal, and the other state means that the side projection of the supporting portion 13 is horizontal. A first arc chamfer 17 is set at the connection position between the limiting portion 12 and the supporting portion 13, and a second arc chamfer 18 is set at the connection position between the supporting portion 13 and the installation portion 11. The setting of the arc chamfer makes the charging pile 100 more beautiful and not easy to scratch the hand. The chamfer radius of the first arc chamfer 17 is in a range from 4 mm to 30 mm, preferably from 8 mm to 12 mm. The chamfer radius of the second arc chamfer 18 is in a range from 15 mm to 45 mm, preferably in a range from 25 mm to 35 mm. The side a of the supporting portion and the side b of the limiting portion are basically in the same plane, so that a relatively complete housing 10 is provided, and the appearance is more beautiful.

In an embodiment, the side projection of the supporting portion 13 can also be in any shape, such as in a ladder shape, an oblique line shape and an arc shape, so that not only the appearance of the charging pile 100 is beautiful, but also a stepped shape allows the charging gun cable 30 to be stuck on each step. The oblique line shape is simple to open the mold, and the mold cost is relatively low. The arc shape is simple to open the mold and can accommodate more than one or two circles of the charging gun cable 30.

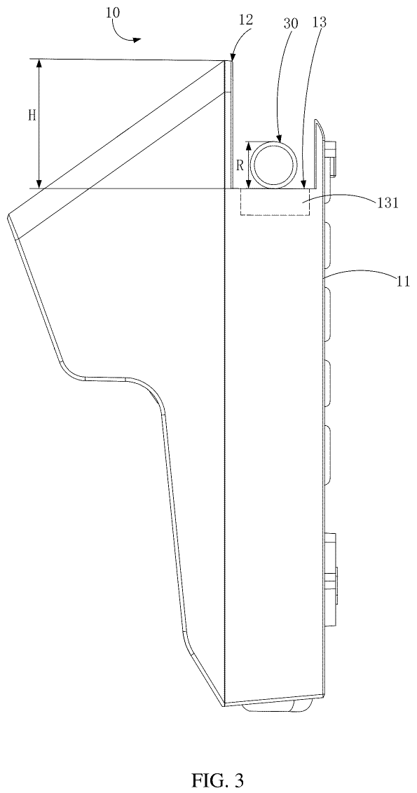

Furthermore, as shown in FIG. 2 and FIG. 3, the vertical distance H between the supporting portion 13 and the top end of the limiting portion 12 is greater than a cross-sectional radius R of the charging gun cable 30, making it easier to clamp the charging gun cable 30.

Further, as shown in FIG. 4 and FIG. 5, the housing 10 further includes an interaction surface 14, which is located at a side away from the installation portion 11, and is used for the user to operate on the charging pile 100. A convex portion is obliquely extended downward along the top end of the limiting portion 12 on the interaction surface 14, and the convex portion is convexly provided, so that the thickness of the housing 10 can be smaller, thereby reducing the weight of the charging pile 100, reducing materials, and reducing costs. An accommodation cavity 15 for holding a charging gun tip 40 is provided in the convex portion, and a gun seat 16 is movably provided in the accommodation cavity 15. When charging is not required, the charging gun tip 40 is plugged into the gun seat 16, and the charging gun tip 40 is partially placed in the accommodation cavity 15. The angle θ between the top surface of the convex portion and the vertical direction is in a range form 0° to 60°, which conforms to the ergonomic design. The user can operate the charging pile 100 without bending over, and the angle θ is preferably 45°. In this way, after the charging pile 100 is installed, the user can directly see the information, such as the indicator light and the screen on the interaction surface 14 without bending over.

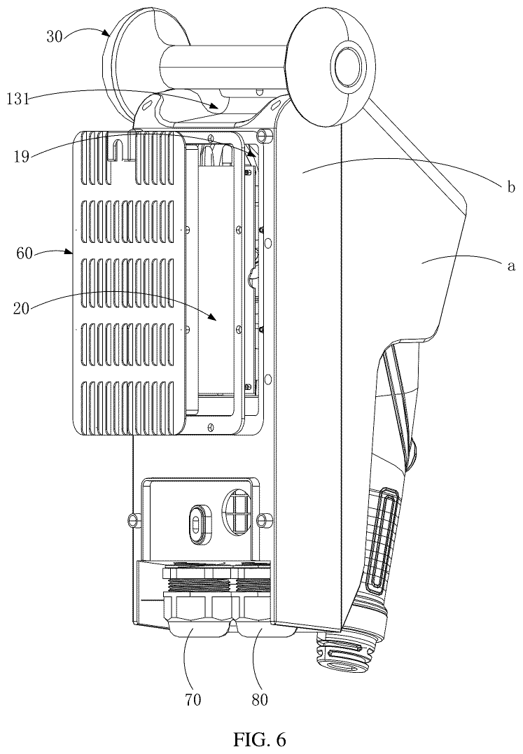

Further, as shown in FIG. 6, the housing 10 further includes a front housing, a rear housing and a heat dissipation housing 60. The interaction surface 14 is provided in the front housing, and the front housing covers the rear housing to form a cavity. The electric control component 20 is provided in the cavity. The limiting portion 12 includes the top of the front housing and the top of the rear housing. The supporting portion and the installation portion are both provided on the rear housing. The rear housing is provided with a through frame 19, and the heat dissipation housing 60 covers the through frame 19. The surface of the heat dissipation housing 60 facing the outside and the surface of the rear housing facing the outside are in the same plane, or are approximately in the same plane. The heat dissipation housing 60 is attached to the electric control component 20, and the heat dissipation housing 60 is provided with a plurality of vents, so that the hot gas of the electric control component 20 is dissipated to the outside through the vents, thereby improving the heat dissipation efficiency.

In an embodiment, a groove 131 with the same size as the electric control component 20 is formed at one end of the heat dissipation housing 60 near the electric control component 20 to accommodate part of the electric control component 20 and limit the movement of the electric control component 20 in the length or width direction. The electric control component 20 is fixed with fasteners, such as screws, to limit its movement in the thickness direction.

Further, as shown in FIG. 2 to FIG. 6, a plurality of protrusion portions are provided at the rear housing, which can prevent the installation portion 11 from directly contacting the wall plate 200, which may cause shaking (if the wall surface is uneven). In addition, a heat dissipation space for air heat exchange can be reserved between the installation portion 11 and the wall plate 200, thereby improving heat dissipation efficiency.

Further, as shown in FIG. 6, the rear housing is also provided with a charging gun cable interface 70 and a cable interface 80. The charging gun cable interface 70 and the cable interface 80 are provided for the charging pile 100. The charging gun cable interface 70 is connected to the charging gun tip 40 or the vehicle. The cable interface 80 is connected to the mains supply (110V, 220V).

### The Second Embodiment

As shown in FIG. 1 and FIG. 3, in addition to the above-mentioned method of limiting the charging gun cable 30 on the supporting portion 13 between the limiting portion 12 and the wall plate 200, the installation portion 11 can also be extended in the vertical upward direction to be higher than the supporting portion 13. In an embodiment, the charging pile 100 includes a housing 10, an electric control component 20, a charging gun cable 30 and a charging gun tip 40. The electric control component 20 is provided in the housing 10, and is configured to convert the mains supply into a safe current (including the alternating current and the direct current) suitable for charging electric vehicles. The electric control component 20 is a general term for control panels and various integrated components.

One end of the charging gun cable 30 is electrically connected to the electric control component 20, and the other end is connected to the charging gun tip 40. The charging gun tip 40 is plugged into the charging interface of the electric vehicle to charge the vehicle. That is, the charging gun tip 40 is plugged into the charging interface of the vehicle, and the electric control component 20 converts the mains supply into a safe current suitable for charging the electric vehicle and finishes the charging through the charging gun cable 30 and the charging gun tip 40.

The housing 10 includes an installation portion 11, a limiting portion 12 provided opposite to the installation portion 11, and a supporting portion 13 located between the installation portion 11 and the limiting portion 12. The supporting portion 13 is configured to place and store a charging gun cable 30 and support the charging gun cable 30, and the limiting portion 12 is disposed higher than the supporting portion 13 to keep the charging gun cable 30 on the supporting portion 13. That is, in the vertical direction, the height of the limiting portion 12 is greater than height of the supporting portion 13, so that the limiting portion 12 protrudes from (is higher than) the supporting portion 13 in the vertical direction to form a protrusion portion, and the protrusion portion limits the charging gun cable 30 on the supporting portion 13. After using the charging gun cable 30, the charging gun cable 30 is placed on the supporting portion 13 in time to prevent the charging gun cable 30 from being crushed by a vehicle or stepped on by a user, resulting in damage to the charging gun cable 30. In addition, a supporting portion 13 is directly provided on the charging pile 100 to support the charging gun cable 30 without an additional storage device, so that the charging pile 100 has a compact structure, a reduced volume, to avoid occupying space, and as many charging piles 100 as possible can be provided in a limited space to meet user needs. A groove 131 is provided at the middle position of the supporting portion 13, and the groove 131 allows part of the charging gun cable 30 on the supporting portion 13 to be in a suspended state. That is, the groove 131 is provided at the middle position of the supporting portion 13, so that the supporting portion 13 forms a structure with high edges on both sides and a middle depression. The charging gun cable 30 is horizontally placed at the supporting portion 13, and its two sides divided by the groove 131 support the charging gun cable 30. There is a gap between the charging gun cable 30 at the position of the groove 131 and the bottom of the groove 131, so that part of the charging gun cable 30 located on the supporting portion 13 is in a suspended state. The length of the groove 131 in the direction from the installation portion 11 to the limiting portion 12 is greater than a diameter of the charging gun cable 30, and a gap is set in the radial direction of the charging gun cable 30 for the user's fingers to reach, so that the user can reach out and hold the charging gun cable 30 to take and place it.

As shown in FIG. 3, the installation portion 11 extends at least in the vertically upward direction, so that the top end of the installation portion 11 is higher than the supporting portion 13. The limiting portion 12 and the installation portion 11 limit the charging gun cable 30 on the supporting portion 13. That is, in the vertical direction, the top end of the installation portion 11 is higher than the supporting portion 13, so that the limiting portion 12, the supporting portion 13 and the top end of the installation portion 11 form a limiting space, and the limiting space limits the charging gun cable 30 on the supporting portion 13, that is, the charging gun cable 30 is placed on the supporting portion 13, and the limiting portion 12 and the top end of the installation portion 11 can limit the charging gun cable 30 on the supporting portion 13. In this way, the charging gun cable 30 does not need to be limited by the wall plate 200, the fixed installation method can be flexibly applied in the charging pile 100, and the charging pile 100 can be directly fixed on the ground, or fixed on the wall plate 200. In addition, the structure is compact and the volume is reduced.

### The Third Embodiment

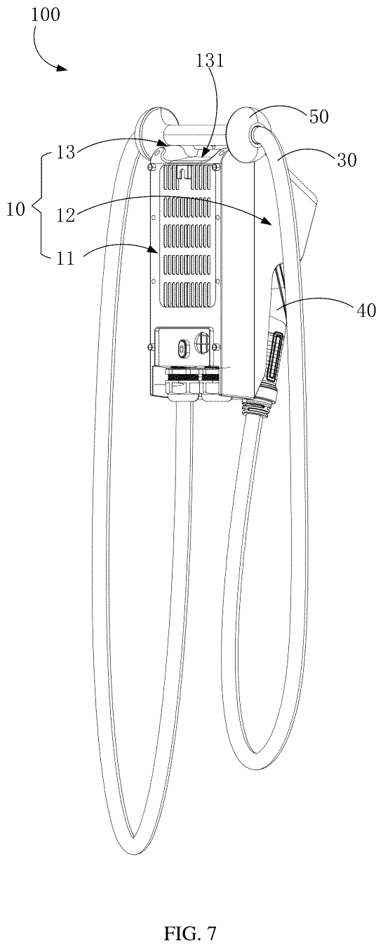

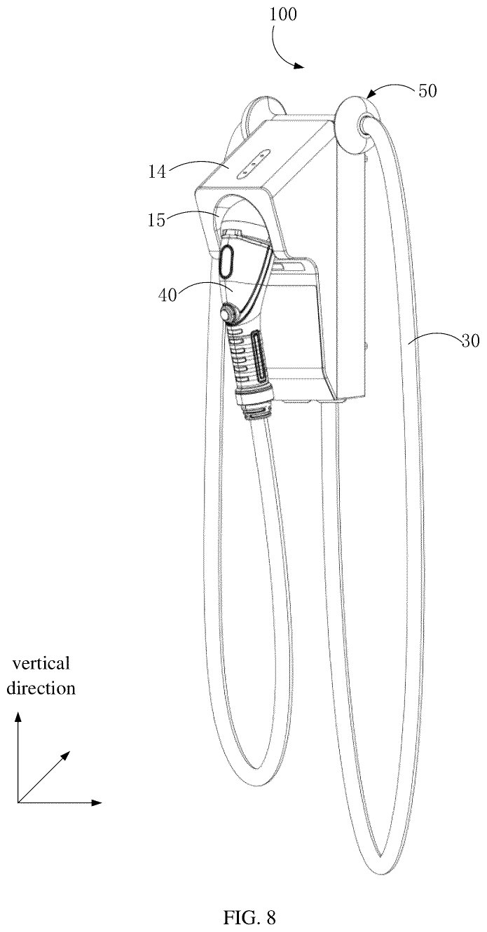

As shown in FIG. 7 to FIG. 10, embodiments of the present application also disclose a charging pile 100, which is installed on a wall plate extending in a vertical direction, such as a wall surface or a column, and is configured to charge an electric vehicle.

The charging pile 100 includes a housing 10, an electric control component 20, a charging gun cable 30, a charging gun tip 40, and a line holder 50. The electric control component 20 is provided in the housing 10, and is configured to convert the mains supply into a safe current (including the alternating current and the direct current) suitable for charging electric vehicles. The electric control component 20 is a general term for a control panel and various integrated components.

One end of the charging gun cable 30 is electrically connected to the electric control component 20, and the other end is connected to the charging gun tip 40. The charging gun tip 40 is configured to be plugged into the charging interface of the electric vehicle to charge the vehicle, that is, the charging gun tip 40 is plugged into the charging interface of the vehicle, and the electric control component 20 converts the mains supply into a safe current suitable for charging the electric vehicle and finishes the charging through the charging gun cable 30 and the charging gun tip 40.

The line holder 50 protects the charging gun cable 30 to a certain extent. The line holder 50 is sleeved outside the charging gun cable 30, and then the charging gun tip 40 is fixedly installed on one end of the charging gun cable 30, so that the line holder 50 is limited between the housing 10 and the charging gun tip 40 to prevent the line holder 50 from falling. The user can take the charging gun cable 30 by taking the line holder 50. The line holder 50 is convenient for the user to take the charging gun cable 30.

The housing 10 includes an installation portion 11 disposed close to a wall plate 200, a limiting portion 12 provided opposite to the installation portion 11, and a supporting portion 13 located between the installation portion 11 and the limiting portion 12. The supporting portion 13 is used for accommodating a line holder 50, and the limiting portion 12 is disposed higher than the supporting portion 13 to keep the line holder 50 on the supporting portion 13. That is, in the vertical direction, the height of the limiting portion 12 is greater than height of the supporting portion 13, so that the limiting portion 12 protrudes from (is higher than) the supporting portion 13 in the vertical direction to form a protrusion portion, which limits the line holder 50 on the supporting portion 13, and the line holder 50 can be promptly removed after the charging gun cable 30 is used, which can prevent the charging gun cable 30 from being crushed by the vehicle or stepped on by the user, resulting in damage to the charging gun cable 30. In addition, the supporting portion 13 is directly set on the charging pile 100 to support the line holder 50 without an additional storage device, so that the charging pile 100 has a compact structure, thereby reducing the volume and avoiding occupying space.

Further, a groove 131 is provided at the middle position of the supporting portion 13, and the line holder 50 located at the groove 131 is in a suspended state, which is convenient for users to take the line holder 50. The groove 131 is provided with a notch facing the installation portion 11, and the notch is specifically a gap. The notch makes the groove 131 pass through the supporting portion 13, and the user puts his hand into the notch to take the line holder 50, so that the user can more conveniently take the line holder 50. The cross-sectional radius of the two ends of the line holder 50 is greater than the cross-sectional radius of the middle position of the line holder 50. That is, two ends of the line holder 50 are respectively the first lifting portion 51 and the second lifting portion 51, and the middle position of the line holder 50 is specifically the gripping portion 52. When the line holder 50 is placed on the supporting portion 13, two ends of the line holder 50 respectively abut the wall plate 200, so that there is a gap between the middle position of the line holder 50 and the wall plate 200 for the finger to reach, so that the user's hand can hold the gripping portion 52 to take the charging gun cable 30 from the supporting portion 13. Of course, a hole with a larger width can be directly dug in the middle position of the supporting portion 13 to form a groove 131, which is convenient for holding the line holder 50.

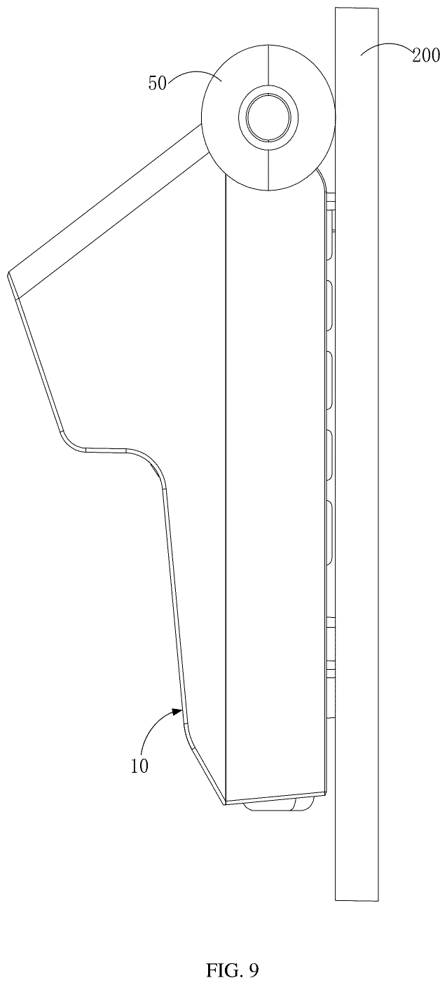

Further, as shown in FIG. 9, the top end of the installation portion 11 is disposed lower than the supporting portion 13, and the limiting portion 12 and the wall plate 200 limit the line holder 50 on the supporting portion 13. That is, the installation portion 11 of the charging pile 100 is fixed on the wall plate 200, so that the limiting portion 12 and the wall plate 200 form a limiting space, thereby limiting the line holder 50 on the supporting portion 13. The charging pile 100 can limit the line holder 50 on the supporting portion 13 in virtue of the wall plate 200, and no additional storage device is required, so that the charging pile 100 has a compact structure and a reduced volume. The line holder 50 is provided with a gap for fingers to reach, which is more convenient for users to take the line holder 50, and then convenient for users to take the charging gun cable 30. When charging, the charging gun cable 30 falls to the ground, and the line holder 50 can prevent the outer layer of the charging gun cable 30 from being damaged by friction with the ground or contaminated by sewage, and can avoid that hands are soiled by sewage when the charging gun cable 30 is picked up from the ground.

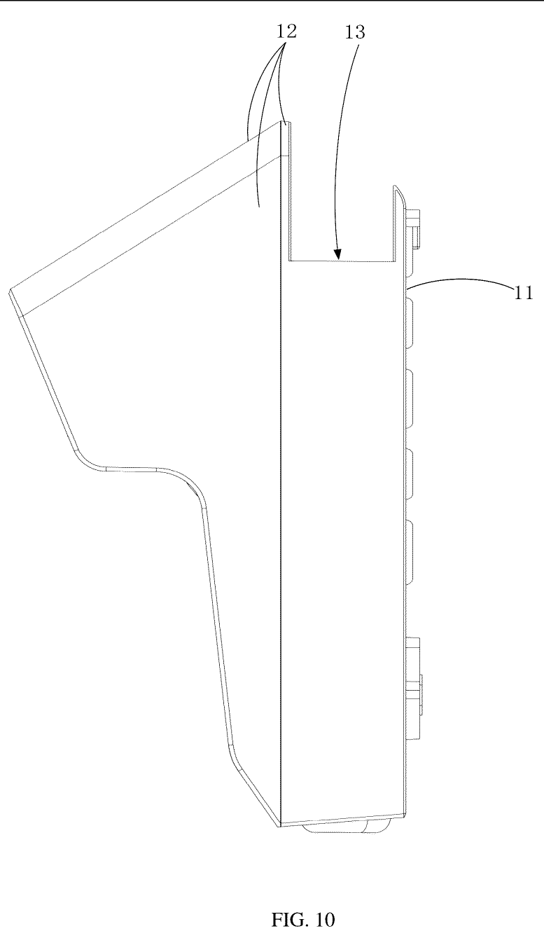

Further, as shown in FIG. 10, the installation portion 11 extends at least in the vertically upward direction so that the top end of the installation portion 11 is higher than the supporting portion 13, and the limiting portion 12 and the installation portion 11 limit the line holder 50 on the supporting portion 13. That is, in the vertical direction, the top end of the installation portion 11 is higher than the supporting portion 13, so that the limiting portion 12, the supporting portion 13 and the top end of the installation portion 11 form a limiting space, and the limiting space limits the charging gun cable 30 on the supporting portion 13. That is, the charging gun cable 30 is placed on the supporting portion 13, and the limiting portion 12 and the top end of the installation portion 11 can limit the charging gun cable 30 on the supporting portion 13. Therefore, there is no need to limit the line holder 50 with the help of the wall plate 200, so that the fixed installation method can be flexibly applied in the charging pile 100, and the charging pile 100 can be directly fixed on the ground, or fixed on the wall plate 200. In addition, the structure is compact and the volume is reduced.

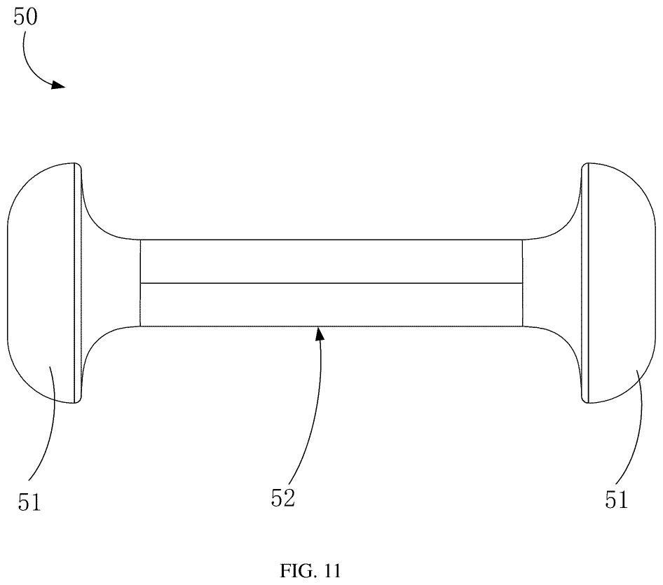

Further, as shown in FIG. 11, the line holder 50 is shaped in a dumbbell, and the length of the middle position of the line holder 50 is slightly greater than the length of the line connecting the two side surfaces of the supporting portion 13, so that the line holder 50 can be stuck on the supporting portion 13. There is a matching gap between the line holder 50 and the charging gun cable 30, so that the line holder 50 can move on the charging gun cable 30. The line holder 50 is made of a flexible material with elastic recovery to prevent the hard material from scratching the charging gun cable 30.

### The Fourth Embodiment

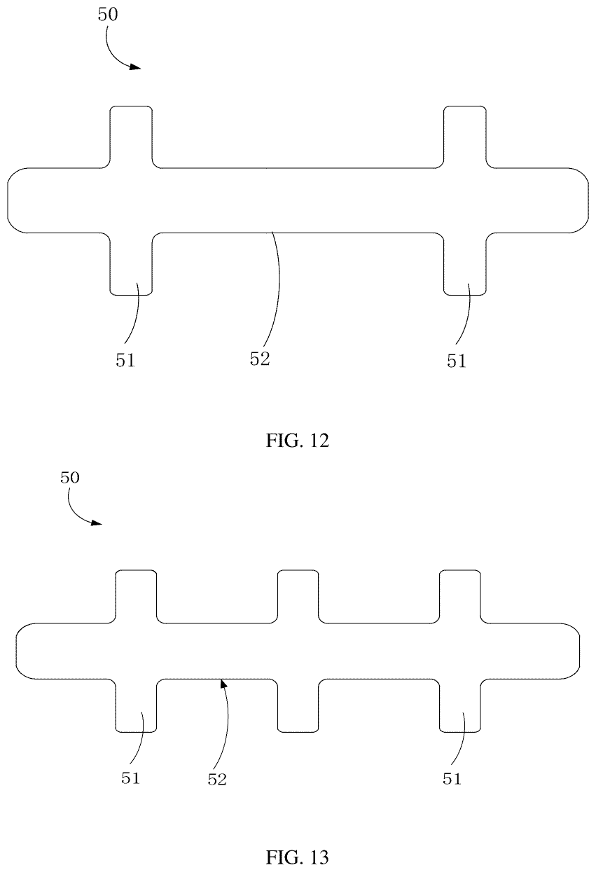

As shown in FIG. 12, in addition to the dumbbell shape of the above-mentioned line holder, the line holder 50 can be in other shapes, and the line holder 50 includes a lifting portion 51 and a gripping portion 52. The circumferential size of the lifting portion 51 is larger than the circumferential size of the gripping portion 52, so that there is a gap between the lifting portion 51 and the supporting portion 13 for the finger to reach. In an embodiment, the line holder 50 includes two lifting portions 51 and a gripping portion 52. The gripping portion 52 is disposed horizontally between the two lifting portions 51. When the line holder 50 is placed on the supporting portion 13, the two lifting portions 51 respectively abut against the wall plate 200, so that there is a gap between the gripping portion 52 and the wall plate 200 for fingers to reach, which makes it more convenient for users to take the line holder 50, and further facilitates users to take the charging gun cable 30.

In an embodiment, as shown in FIG. 13, an inner recess for accommodating fingers is provided at the gripping portion 52, which makes it convenient for people with smaller palms to hold the gripping portion 52, thereby facilitating users taking the line holder 50.

The above embodiments are only used to illustrate the technical solutions of the present application, rather than to limit them. Under the concept of the present application, the technical features in the above embodiments or different embodiments may also be combined, the steps may be implemented in any order, and there are many other changes in different aspects of the present application as described above, which are not provided in detail for the sake of simplicity. Although the present application has been described in detail with reference to the aforementioned embodiments, those skilled in the art should understand that the technical solutions described in the aforementioned embodiments may still be modified, or some of the technical features may be replaced by equivalents. However, these modifications or replacements do not deviate the essence of the corresponding technical solutions from the scope of the technical solutions of the embodiments of the present application.

What is claimed is:

1. A charging pile, comprising:
a housing;
an electric control component provided in the housing; and
a charging gun cable;
wherein one end of the charging gun cable is electrically connected to the electric control component, and another end of the charging gun cable is connected to a charging gun tip;
the housing comprises an installation portion disposed close to a wall plate, a limiting portion disposed opposite to the installation portion, and a supporting portion provided between the installation portion and the limiting portion;
the limiting portion is disposed higher than the supporting portion to keep the charging gun cable on the supporting portion; and
a groove is provided at a middle position of the supporting portion, and the groove is configured to enable part of the charging gun cable on the supporting portion to be in a suspended state.

2. The charging pile according to claim 1, wherein:
the installation portion is configured to extend at least along a vertically upward direction, to make a top end of the installation portion higher than the supporting portion; and
the limiting portion and the installation portion are configured to limit the charging gun cable on the supporting portion.

3. The charging pile according to claim 1, wherein:
a top end of the installation portion is disposed lower than the supporting portion; and
the limiting portion and the wall plate are configured to limit the charging gun cable on the supporting portion.

4. The charging pile according to claim 3, wherein the groove is provided with a notch facing the installation portion.

5. The charging pile according to claim 3, wherein a side projection of the supporting portion is horizontal; a connection position between the limiting portion and the supporting portion is provided with a first arc chamfer, and a connection position between the supporting portion and the installation portion is provided with a second arc chamfer.

6. The charging pile according to claim 1, wherein:
a side of the supporting portion and a side of the limiting portion are in a same plane; and/or
a vertical distance between the supporting portion and a top end of the limiting portion is greater than a cross-sectional radius of the charging gun cable.

7. The charging pile according to claim 1, wherein the housing further comprises an interaction surface, and the interaction surface is provided at a side of the housing away from the installation portion.

8. The charging pile according to claim 7, wherein:
the interaction surface is provided with a convex portion extending obliquely downward along a top end of the limiting portion;
an accommodation cavity for holding the charging gun tip is provided in the convex portion; and
a angle between a top surface of the convex portion and a vertical direction is in a range of 0° to 60°.

9. A charging pile, comprising:
a housing;
an electric control component provided in the housing;
a charging gun cable, wherein one end of the charging gun cable is electrically connected to the electric control component, and another end of the charging gun cable is connected to a charging gun tip; and
a line holder sleeved outside the charging gun cable;
wherein the housing comprises an installation portion disposed close to a wall plate, a limiting portion disposed opposite to the installation portion, and a supporting portion provided between the installation portion and the limiting portion; and
the limiting portion is disposed higher than the supporting portion to keep the line holder on the supporting portion.

10. The charging pile according to claim 9, wherein the line holder comprises a lifting portion and a gripping portion, and a circumferential size of the lifting portion is larger than a circumferential size of the gripping portion, to allow a gap between the lifting portion and the supporting portion for fingers to reach.

11. The charging pile according to claim 9, wherein a groove is provided in a middle of the supporting portion.

12. The charging pile according to claim 11, wherein:
the groove is provided with a notch facing the installation portion;
each cross-sectional radius of both ends of the line holder is greater than a cross-sectional radius of a middle position of the line holder; and
in response to that the line holder is provided at the supporting portion, both ends of the line holder are abutted against the wall plate, to allow a gap between a middle position of the line holder and the wall plate for fingers to reach.

13. The charging pile according to claim 9, wherein:
a top end of the installation portion is disposed lower than the supporting portion, and the limiting portion and the wall plate are configured to limit the line holder on the supporting portion; or
the installation portion is configured to extend at least along a vertically upward direction to make a top end of the installation portion higher than the supporting portion, and the limiting portion and the installation portion are configured to limit the line holder on the supporting portion.

14. The charging pile according to claim 9, wherein:
the line holder is shaped in a dumbbell;
a length of a middle position of the line holder is greater than a length of a line connecting two side surfaces of the supporting portion; and/or
a matching gap is provided between the line holder and the charging gun cable; and/or
the line holder is made of a flexible material with elastic recovery.
